(19) United States
(12) Patent Application Publication
(10) Pub. No.: US 2015/0067073 A1
(43) Pub. Date: Mar. 5, 2015

(54) RESTART CAPABILITY IN MESSAGE CAMPAIGN

(71) Applicants: DIRK WAGNER, Marpingen (DE); Jörg Steinmann, Volklingen (DE); Wolfgang Gentes, Zweibrucken (DE)

(72) Inventors: DIRK WAGNER, Marpingen (DE); Jörg Steinmann, Volklingen (DE); Wolfgang Gentes, Zweibrucken (DE)

(21) Appl. No.: 14/018,418

(22) Filed: Sep. 5, 2013

(51) Int. Cl. H04L 12/58

(52) U.S. Cl. CPC H04L 51/063
USPC 709/206

(57) ABSTRACT

In an embodiment, a message campaign is defined based on a received plurality of inputs and received target group to be assigned to the message campaign. In response to receiving an execute instruction from a user interface, a mass data run object instance is created corresponding to the message campaign. Schedule parameters such as date and time are specified to schedule execution of the created mass data run object instance. The mass data run object instance groups the recipients of the target group into packages. Execute the grouped packages in parallel in batches to send personalized communication to the recipients grouped in the packages by creating a corresponding instance for the recipients. In case one or more packages fails to execute, restart execution of the one more packages to send personalized communication to the recipients in the one or more packages. The recipients receive personalized communication only once.

### BACKGROUND

Some enterprises are required to market their products, services and offers to customers through various modes of message campaigns such as email campaign, letter campaign, phone campaign, short message service (SMS) campaign, etc. In email campaigns, enterprises are required to send large number of emails to customers, referred to as bulk emails. Bulk emails are generally sent in thousands. In such email campaigns, when numerous emails are sent, it is very likely that some of the emails sent can fail to reach the customers. In such a scenario, processing the failed emails is a challenge because customers should not receive redundant emails.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an exemplary environment for restart capability in email campaign, according to an embodiment.

FIG. 2 illustrates a user interface for defining an email campaign, according to one embodiment.

FIG. 3 illustrates a user interface for scheduling an email campaign, according to one embodiment.

FIG. 4 illustrates a user interface providing an overview of a defined and scheduled email campaign, according to one embodiment.

FIG. 5 illustrates a user interface for displaying a result of execution of a scheduled email campaign, according to one embodiment.

FIG. 6 illustrates a user interface for providing execution details of an executed email campaign, according to one embodiment.

FIG. 7 is a block diagram illustrating details of an execution of an email campaign, in one embodiment.

FIG. 8 is a flow diagram illustrating a process of restart capability in message campaign, according to one embodiment.

FIG. 9 is a block diagram of an exemplary computer system, according to one embodiment.

### DETAILED DESCRIPTION

Embodiments of techniques for restart capability in message campaign are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Enterprise uses message campaigns such as email campaign, short message service (SMS) campaign, letter campaign, phone campaign, etc., to contact customers, business partners, vendors, etc., to market products, services and offers associated with the enterprise. Typically, enterprises have hundreds or thousands of business partners and customers. Campaigns such as message campaign and marketing campaigns require communications such as email, SMS and letter to be sent in huge volume referred to as bulk messaging. Bulk messaging is dissemination of large number of messages to people across the globe. Typically, in such message campaigns, bulk messaging is processed in batches referred to as batch processing. Batch processing is execution of series of programs or jobs on a processing unit without manual intervention.

As an example, in a scenario of bulk messaging to one hundred thousand customers, there can be one thousand batch jobs where the batch jobs comprising hundred customers each can be defined. While execution of one thousand batch jobs, some issues can occur such as some of the batch jobs failing, some of the batch jobs gets aborted, or the server executing the batch jobs getting crashed, etc. In such scenarios, the batch job might be partially processed where a first few customers among the hundred customers may be sent messages while the remaining few customers may not have been sent messages. Typically, the failed batch job is executed again to send message to the remaining few customers. However, while executing the batch job again, first few customers in the batch job who have already received the message are sent message once again causing redundancy.

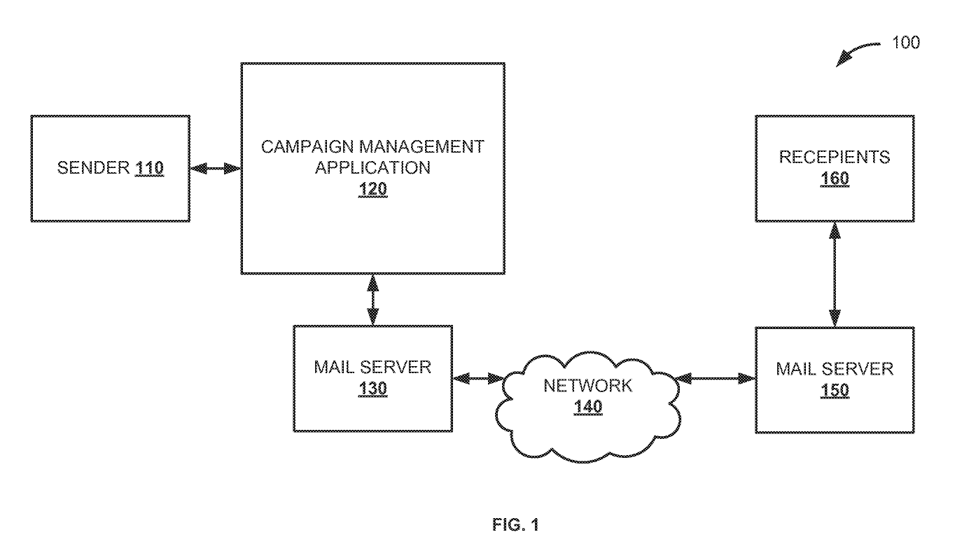

There is a need to process only the remaining few customers and to send messages to them, because while processing the remaining few customers, first few customers in the batch jobs who have already received the message should not be sent message again. Restart capability in messaging campaign processes the remaining few customers and send messages only to them. The example embodiments illustrated below using FIG. 1 to FIG. 8, describe in detail the restart capability in email campaign. However it should be appreciated that other campaigns such as short message service (SMS) campaign, letter campaign, phone campaign, etc., can be implemented in similar way as the email campaign.

FIG. 1 is a block diagram illustrating an overview of an exemplary environment for restart capability in email campaign, according to an embodiment. The exemplary environment 100 is shown containing sender 110, campaign management application 120, mail server 130 of sender, network 140, mail server 150 of recipient and recipients 160. In one embodiment, sender is an email sender and recipient is an email recipient. Merely for illustration, only a representative number and type of entities is shown in FIG. 1. Each system/device of FIG. 1 is described below in further detail. Network 140 provides connectivity between mail server 130 of sender and mail server 150 of recipient. Network 140 may be implemented using protocols such as Transmission Control Protocol (TCP) and/or Internet Protocol (IP).

A message campaign such as an email campaign can be defined by receiving inputs such as name, start date, end date, email template, etc., and receiving a target group of recipients from the sender 110. The sender 110 schedules to execute the defined email campaign and to send email to recipients 160. In campaign management application 120, the target group of recipients is grouped into packages. These packages are executed in parallel in batches of defined batch size to send personalized email or personalized communication to the recipients 160 in the target group. The personalized emails sent are dispatched to the recipients 160 by the mail server 150 of the recipient. In case few packages fail during execution, the failed packages are restarted, where the personalized email is sent only to the recipients in the failed packages skipping the recipients in the successful packages who have already received the personalized email. Therefore the recipients receive only one copy of the personalized email.

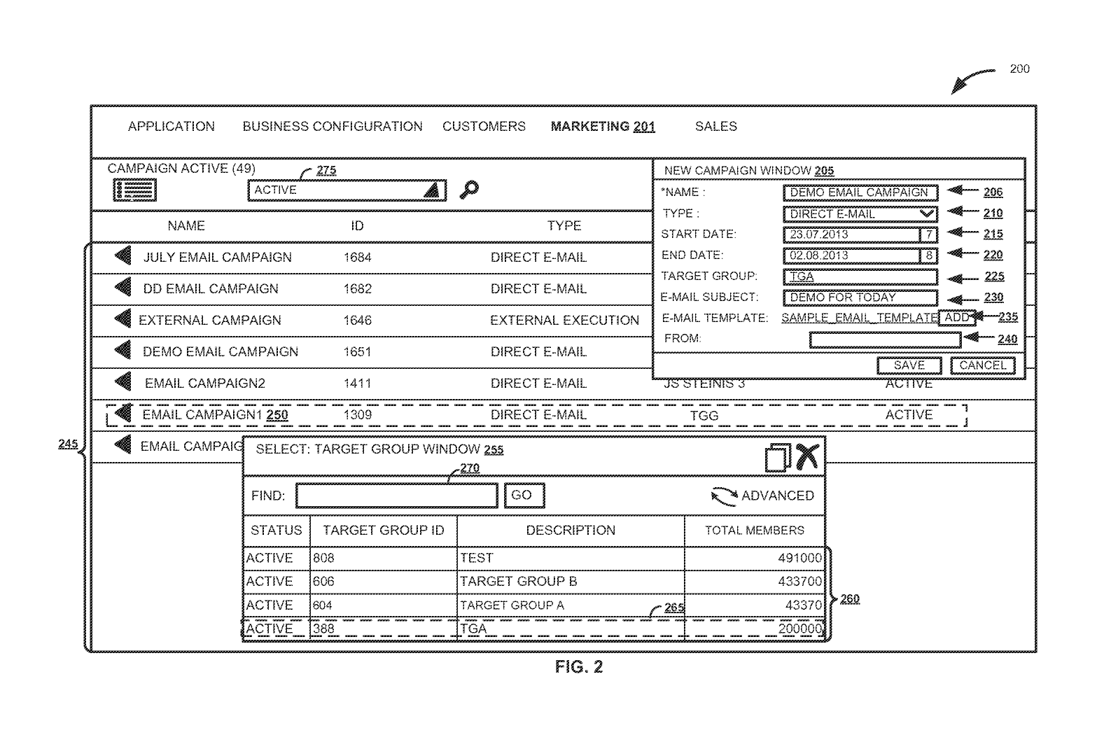

FIG. 2 illustrates a user interface for defining an email campaign, according to one embodiment. In a campaign management application, list of campaigns defined by the senders may be listed in a user interface 200 of the campaign management application. A new email campaign can be defined using a new campaign window 205 in the campaign management application user interface 200 as shown in FIG. 2. Sender can provide inputs such as ‘name’ 206, ‘type’ 210, ‘start date’ 215, ‘end date’ 220, ‘target group’ 225, ‘email subject’ 230, ‘email template’ 235 and ‘from’ 240 email address, to define a new email campaign in the new campaign window 205. Email campaign is identified by the name specified while defining the email campaign such as “demo email campaign” 206. ‘Type’ 210 specifies the type of email campaign such as ‘direct email’, ‘letter’. ‘SMS’ etc. ‘Start date’ 215 and ‘end date’ 220 specifies the start date and the end date of the email campaign “demo email campaign” 206. The defined email campaign named “demo email campaign” 206 may be saved, and the saved email campaigns can be viewed in the campaign list 245 in the user interface 200. For example. “email campaign1” 250 of type “direct email” and target group “TGG” can be viewed in the campaign list 245.

A target group is defined as a group consisting of numerous recipients, typically in denomination of thousands or millions. Recipients in the target group may or may not share similarities, but are considered together as one single group. When the sender clicks on the target group link to select a target group, a new target group window 255 opens up displaying all the stored target groups as shown in 260. For example, target group identifier “TGA” in 265, which is currently in an “active” target group status having “200000” recipients, is selected to be added to the “demo email campaign” 206 in the new campaign window 205. Target group status indicates the status of the target group “TGA”. Specific target groups can also be searched using “find” 270 option provided in a graphical user interface 200 of the campaign management application.

Email templates are predefined and stored in the campaign management application. An email template may be defined using software applications as hypertext markup language pages, with placeholders defined for the recipient's name, recipient's title, etc. While executing the defined email campaign, the placeholders defined in the email template are substituted with recipient information, thereby providing personalized emails to recipients. One of the email templates defined and stored, namely “sample_email_template,” is selected and added to the email template 235 of the new campaign window 205. ‘From’ 240 is used to specify email address from which the email is dispatched to the recipients. The defined email campaign “demo email campaign” 206 can be ‘saved’ or ‘saved and opened’ for viewing in the graphical user interface 200 of the campaign management application. Once saved, the campaign named “demo email campaign” 206 is presented in the campaign list 245 in the user interface 200. Email campaigns can be in different lifecycle statuses such as “active”, “inactive”, “planned”, “finished”, “cancelled”, etc. List of email campaigns in the same lifecycle status can be viewed in the campaign list 245 using the drop down 275 to filter the stored email campaigns, e.g., to list only the “active” email campaigns as illustrated. Similarly, list of email campaigns in the “finished” or “cancelled” lifecycle status can be viewed using the drop down 275.

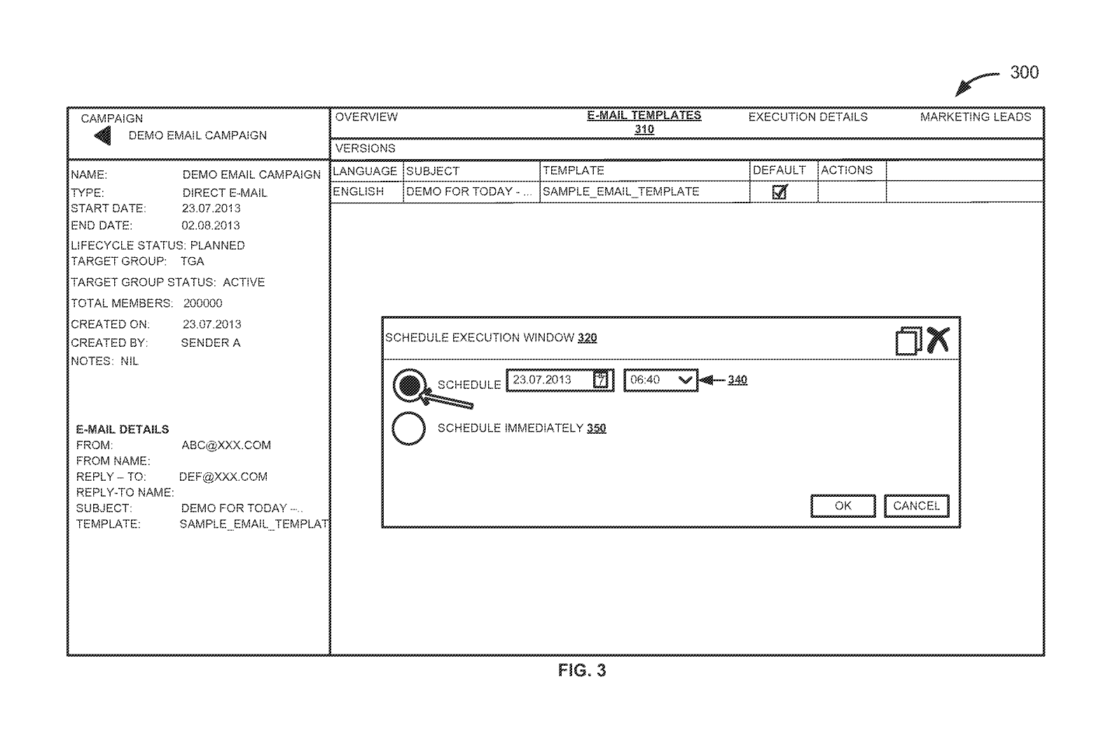

The defined email campaign named “demo email campaign” 206 can be scheduled using a schedule option provided in the campaign management application. FIG. 3 illustrates user interface 300 for scheduling email campaigns, according to one embodiment. Email templates 310 lists the details of email campaigns along with their respective email templates added. The schedule execution window 320 provides option to either schedule the selected email campaign at a specified date and time 340, or schedule the selected email campaign to execute immediately 350. In case, the “demo email campaign” with “sample_email_template” is scheduled to run at a specified date and time, that specific date and time is entered by selecting the schedule option 340. In case the “demo email campaign” with “sample_email_template” is scheduled to run immediately, then the “schedule immediately” 350 option is selected. Based on the selected schedule option, “demo email campaign” with “sample_email_template” is executed.

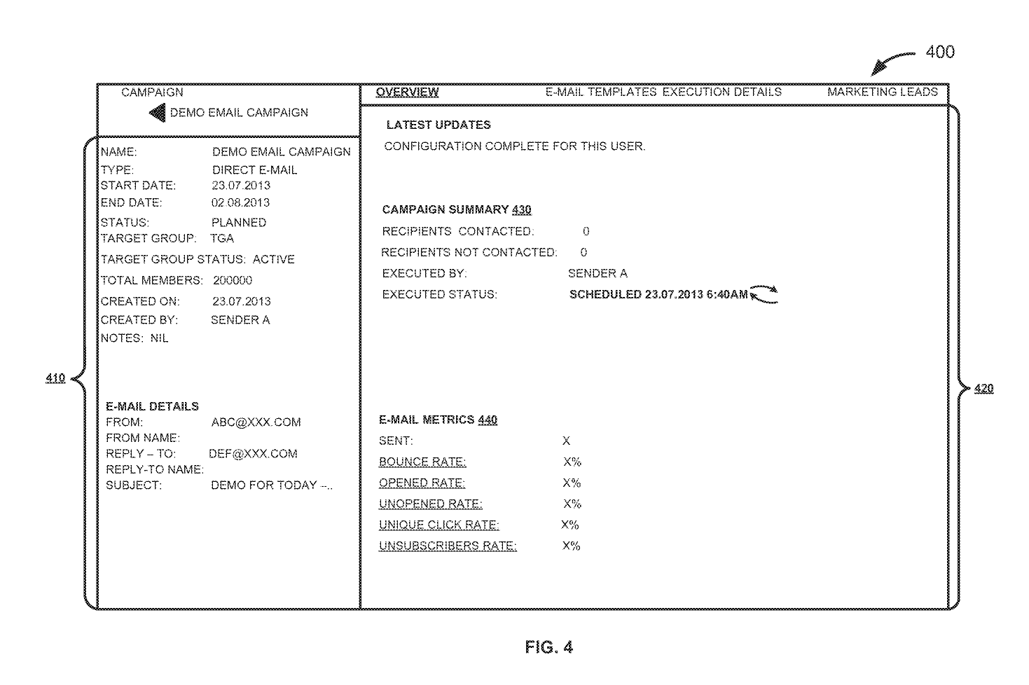

FIG. 4 illustrates user interface 400 providing an overview of a defined and scheduled email campaign, according to one embodiment. The left pane 410 displays the details of the “demo email campaign” provided, e.g., while defining the email campaign in the new campaign window 205 in FIG. 2. For example, details of the “demo email campaign” such as name “demo email campaign”, type “direct e-mail”, start date “23.07.2013”, end date “02.08.2013”, life cycle status “planned”, target group “TGA”, target group status “active”, total recipients “200000”, created on “23.07.2013”, created by “sender A” along with email details are displayed in the left pane 410. Email details include details such as from “abc@xxx.com” email address, reply-to “def@xxx.com” email address, subject and email content. The overview details of the “demo email campaign” displayed in the right pane 420 include campaign summary 430, email metrics 440, etc. Campaign summary 430 provides details of a summary of the email campaign execution, such as recipients contacted, recipients not contacted, executed by “sender A” and executed status as “scheduled 23.07.2013 6:40 AM”. Email metrics 440 provides details such as number of emails sent, email bounce rate, etc.

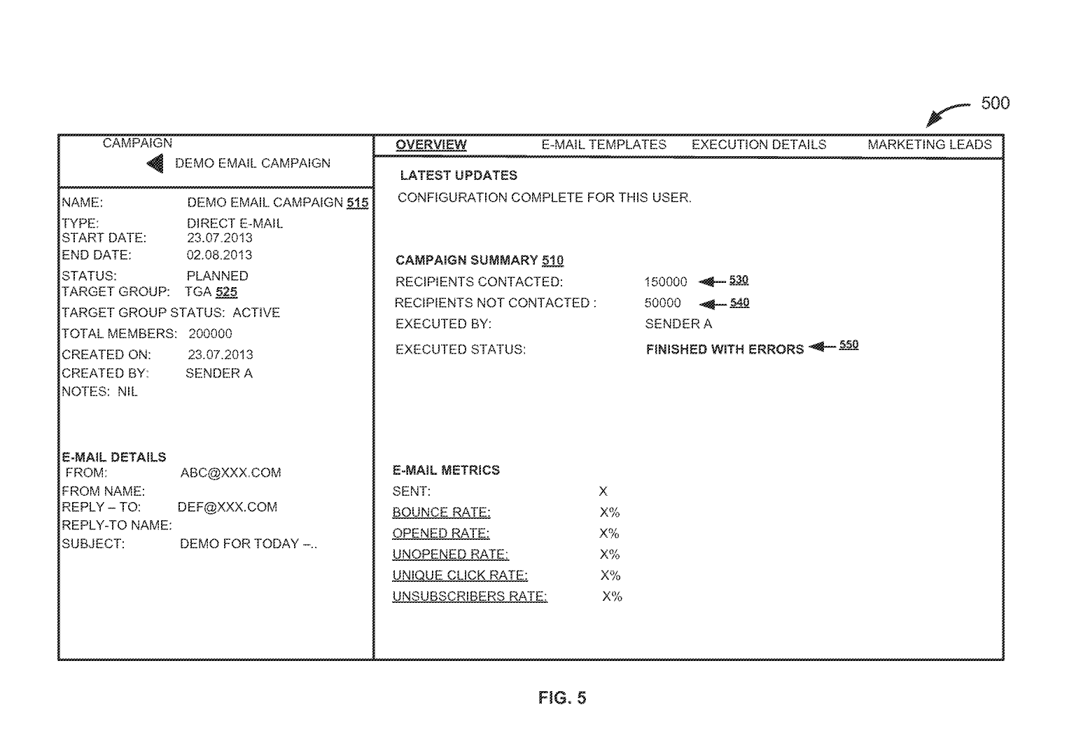

FIG. 5 illustrates user interface 500 for displaying a result of execution of a scheduled email campaign, according to one embodiment. At the scheduled date and time specified in the executed status (e.g., see campaign summary 430 in FIG. 4), the email campaign is automatically executed without manual intervention and the result of the execution is updated in the campaign summary 510. While execution of the email campaign named “demo email campaign” 515, the target group “TGA” 525 is grouped into packages for execution. In one embodiment, validation checks are performed on the details of the email campaign and on information associated with the recipients of the grouped packages, before the recipients are contacted. Validation checks such as verifying if the target group is assigned to the email campaign, verifying if the target group has at least one recipient, verifying if the recipient has subscribed to ‘do not disturb’ in bulk email subscription, etc., are performed on the recipients of target group “TGA” 525. Based on the validation check performed, the “demo email campaign” is executed and the recipients are sent personalized emails. For example, the “demo email campaign” scheduled at “23.07.2013 6:40 AM” (see, campaign summary 430 in FIG. 4) is executed automatically and the result of the execution such as recipients contacted “150000” 530, recipients not contacted “50000” 540, and execution status “Finished with errors” 550 is updated in the campaign summary 510.

In one embodiment, during the execution of the “demo email campaign”, the “200000” recipients in the target group “TGA” 525 are packaged into groups of specified number of recipients per package, to execute the package in parallel in batches. Execution of packages in parallel can be defined using software jobs to simultaneously execute the packages in parallel to increase efficiency of the processing. In one embodiment, the packages can be executed in parallel by multiple processors available at the server device. Number of packages to be executed per batch can be defined by specifying the batch size. For example, “200000” recipients of the target group “TGA” 525 can be packaged in two thousand packages consisting of hundred recipients per package, and two thousand packages can be executed in two hundred batches of a batch size of ten.

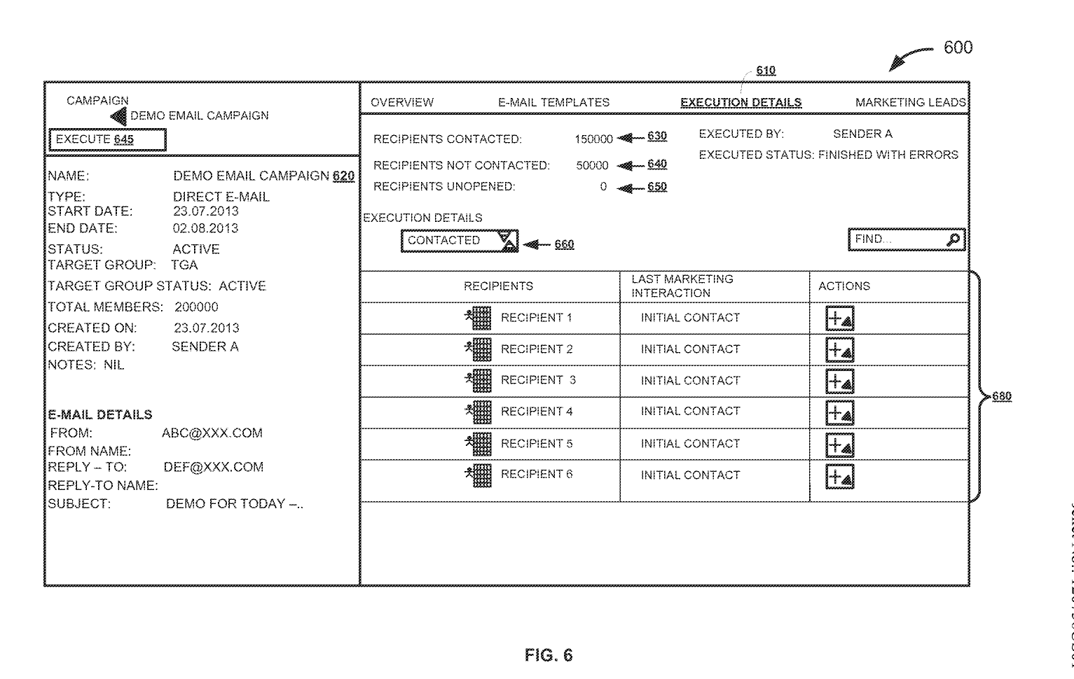

In the campaign summary 510 of the execution of the campaign named “demo email campaign” 515, the “recipients contacted: 150000” 530 indicates that 150000 recipients have successfully received the personalized email, and “recipients not contacted: 50000” 540 indicates that 50000 recipients have not received the personalized email. Hence the execution status is displayed as “Finished with errors” 550. In one embodiment, “Finished with errors” 550 can be a link, which when clicked, provides execution details as shown in FIG. 6 under the user interface tab “execution details” 610 for the “demo email campaign”. FIG. 6 illustrates user interface 600 for providing execution details of an executed email campaign, according to one embodiment. Details of the result of execution of the campaign named “demo email campaign” 620 are displayed such as “recipients contacted: 150000” 630, “recipients not contacted: 50000” 640, “recipients unopened: 0” 650, etc. In the “execution details” 610 provided, a sender, e.g., “sender A,” has an option to view the list of recipients contacted, recipients not contacted, etc., by specifying the appropriate option in the drop down 660. When “recipients contacted” is selected in the drop down 660, list of recipients contacted 680 is displayed. List 680 provides information corresponding to the recipients contacted.

Personalized emails need to be sent again to the “50000” recipients not contacted 640. Accordingly, restart execution of the “demo email campaign” 620 is performed to retry sending personalized email to the “50000” recipients not contacted earlier. The user interface 600 may provide an option “execute” 645 to initiate an execution of the “demo email campaign.” When the “execute” 645 instruction is provided, the execution of “demo email campaign” is restarted for only the “50000” recipients not contacted 640. The successfully contacted “150000” recipients 630 are skipped and are not contacted again, thereby avoiding sending of redundant emails. In one embodiment, if the execution of the email campaign, e.g., the campaign named “demo email campaign” 620, is successful, then the executed status is displayed as “Finished successfully” (not illustrated). “Finished successfully” can be a link which when clicked provides “execution details” of the campaign (e.g., named “demo email campaign” 620). A user interface is provided to display the result of the execution detail of the email campaign. Details of the result of execution of the “demo email campaign” 620 are displayed such as recipients contacted “200000”, recipients not contacted “0”, recipients unopened “0”, etc.

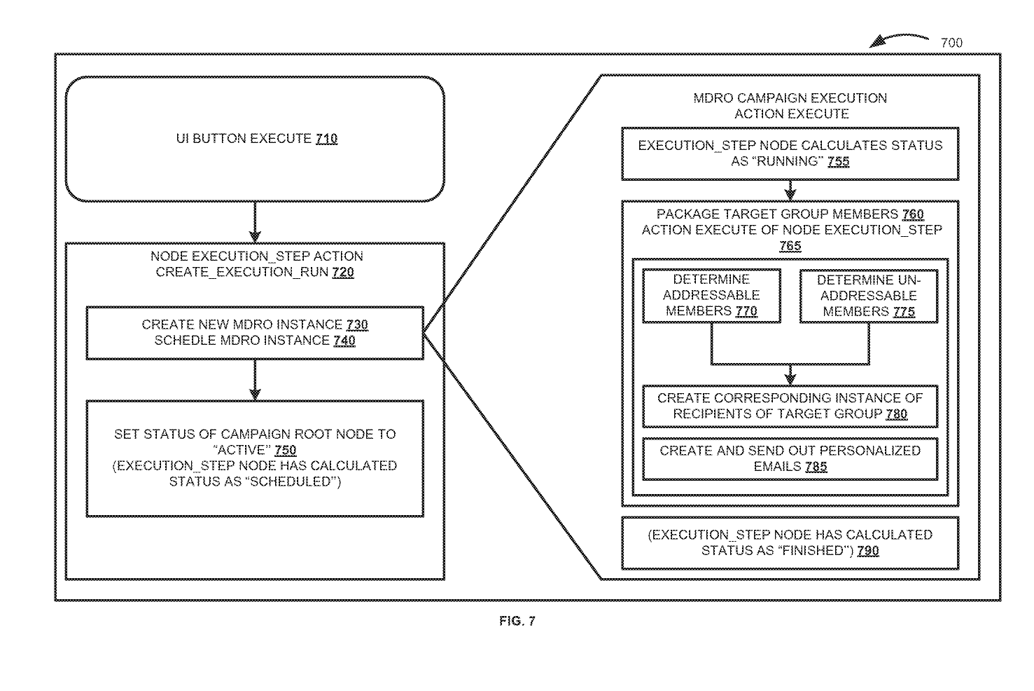

FIG. 7 is a flow diagram illustrating process 700 for generating details for the execution of an email campaign, in one embodiment. When “execute” instruction 710 is received from “sender A”, e.g., by clicking on button “execute” 645 from user interface 600 (FIG. 6), action “create_execution_run” of the email campaign node “execution_step” 720 is called. An action may be a command object with the ability to perform the desired command. The action may also be associated with icon, keyboard press, etc. The “execute” instruction is initialized using the action “create_execution_run.” This action “create_execution_run” creates a new instance of mass data run object (MDRO) 730, corresponding to the email campaign “demo email campaign”. MDRO can be considered as a specialized business object that is configured for a mass data processing task. Real world objects such as customer, sales, etc., are modeled as business objects in a business application system such as campaign management application (e.g., 120 in FIG. 1). For batch processing of email campaign MDRO is used. MDRO may include a common structure to facilitate interaction with applications, business objects, etc. Various elements of MDRO may include actions or operations to be performed, parameters, selections, data, and/or other information to facilitate batch processing. The MDRO may be processed in at least one background job. Background job or process is a computer process that has a lower priority than jobs being run simultaneously which involve any online activity. A background job runs without user intervention.

A user interface of the campaign management application opens a schedule execution window, where the created MDRO instance can be scheduled 740 for execution. Once the execution is scheduled, the user interface of the campaign management application sets the lifecycle status of the “demo email campaign” to “active” 750. The node “execution_step” 720 may get status information in an attribute “executionstatuscode”. “Execution_step” node 720 determines the execution status as “scheduled”. This “executionstatuscode” may be used to show the execution status of the “demo email campaign” execution in the campaign overview. The execution status value will be determined by an action “set_execution_status”. The execution status may have values such as “not scheduled”, “Scheduled”, “running”, “finished successfully”, “finished with errors” and “failed”.

When the execution status value is “not scheduled,” no instance of MDRO is scheduled. When the execution status value is “scheduled,” an instance of MDRO is scheduled. The scheduled instance can be re-scheduled or the scheduling can be removed. Some details of the scheduled email campaign can be changed, while some details of the scheduled email campaign cannot be changed such as execution status, campaign type, etc. For execution status value “running,” an instance of the MDRO is currently running or processed. This execution status value blocks the email campaign for changes. For execution status value “finished successfully,” an instance of the MDRO has been executed successfully without any failure or error. In case some recipients could not be contacted successfully due to unavailability of valid email address, the campaign execution status value may still be “finished successfully”. The execution details can be viewed in the campaign summary such as recipients contacted, recipients not contacted. For this “finished successfully” execution status value, restarting of email campaign is not allowed.

When the execution status value is “finished with errors”, an instance of MDRO has not been executed successfully, i.e. not all packages are executed successfully. In this case, the failed packages can be restarted. If an execution has been aborted, it allows the sender to start the email campaign execution again. The MDRO instance is processed as a background job. Background jobs older than a specified number of days (e.g., after the specified end date) are deleted. If the email campaign is with execution status values such as “running”, “finished with errors” or “cancelled”, changes cannot be made to the target group and changes cannot be made to the target group status as well.

While execution, the MDRO may not set or store information corresponding to target group or target group status. The information associated with the target group is dynamically checked. This dynamic or on-the-fly check has the advantage that the target group does not need to store any target group status information regarding their usage such as, checking the status of the recipients in the target group during the email campaign execution. Thus the MDRO does not need to set a certain target group status each time of execution of the email campaign. Specifically, in case where a MDRO instance gets aborted, no wrong status value would remain in the target group, and thereby no wrong information is provided to the sender in the user interface of the campaign management application. After the completion of execution of the email campaign, the information about the executed campaign corresponding to target group, target group status and packages are saved to a database.

In case an email campaign is restarted or changed, validation checks are performed on the details of the email campaign, before the recipients are contacted. In case the sender wants to change the start date or time of an already scheduled email campaign execution, similar validation checks are performed. If the validation checks are performed successfully, the lifecycle status of the email campaign is determined and set accordingly. For example, the lifecycle status of the email campaign is updated to “Active”. In case no MDRO instance is found, a new MDRO instance is created and the lifecycle status is set to “active”. This new MDRO instance can be scheduled using the schedule execution window (e.g., 320 in FIG. 3).

The MDRO instance is in execution and the “execution_step” node 720 calculates the execution status value as “running” 755. The MDRO reads all the recipients of the target group “TGA”, groups the specified number of recipients into packages 760, and sends these packages to an action “execute” at 765 of the node “execution_step” of the email campaign. The action “execute” of node “execution_step” performs the following functions: a) using the information associated with the recipients of the target group “TGA”, determine if recipients are addressable 770 or if recipients are unaddressable 775; b) create a corresponding instance of all the recipients of the target group “TGA” 780; and c) create and send a personalized email for all the addressable recipients 785. Execution of the scheduled MDRO instance is in parallel batches. These packages are executed in parallel in batches of defined batch size, to send personalized email to the recipients in the target group “TGA”. Recipients who can be reached while sending email are referred to as addressable recipients, and recipients who cannot be reached while sending email are referred to un-addressable recipients. Once the personalized emails are sent to the addressable recipients, the node “execution_step” 720 calculates the execution status of the “demo email campaign” as “finished successfully” 790. This execution status is displayed in the campaign summary section of the user interface.

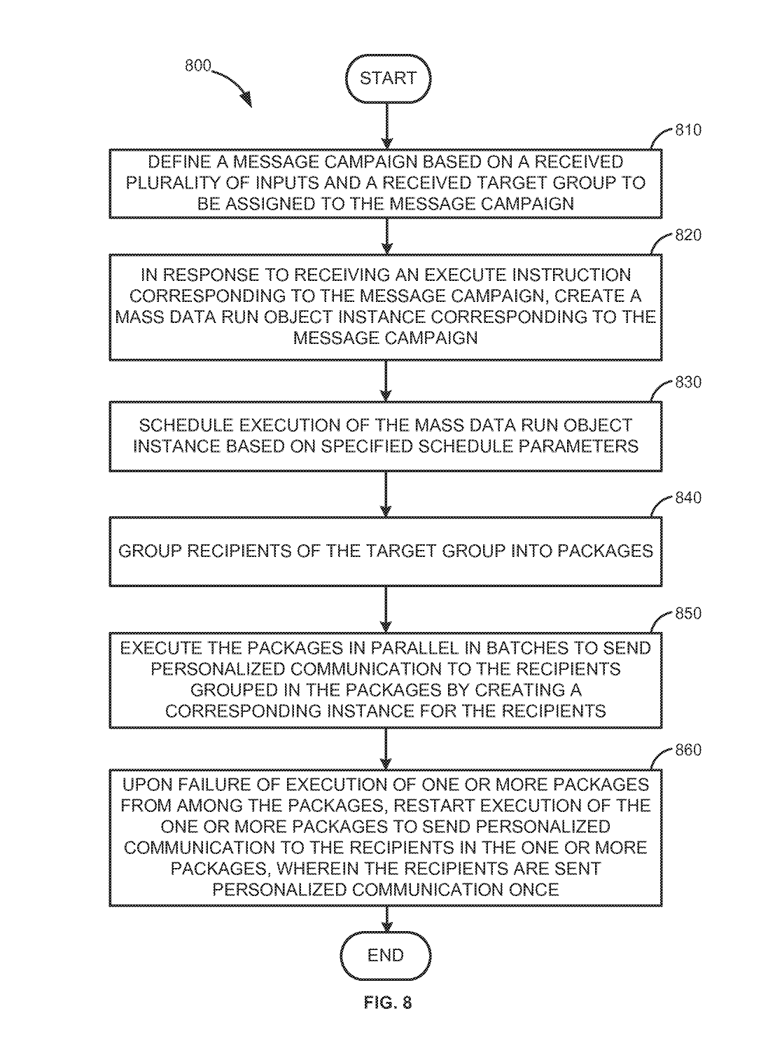

FIG. 8 illustrates a flow diagram of process 800 of restart capability in message campaign, according to one embodiment. At 810, a message campaign is defined based on a received plurality of inputs and received target group to be assigned to the message campaign. Inputs are received from a sender using a user interface of a campaign management application. At 820, an execute instruction is received from the user interface of the campaign management application. In response to receiving the execute instruction a mass data run object instance is created corresponding to the message campaign. The mass data run object is processed in a background job. At 830, schedule parameters are specified to schedule execution of the created mass data run object instance. Schedule parameters such as date and time can be specified. At 840, the mass data run object instance groups the recipients of the target group into packages. At 850, the grouped packages are executed in parallel in batches to send personalized communication to the recipients grouped in the packages by creating a corresponding instance of the recipients in the target group. In case execution of one or more packages from among the packages fails to execute, at 860, execution of the one more failed packages is restarted to send personalized communication to the recipients in the one or more packages.

The various embodiments described above have a number of advantages. The packages are processed in parallel to keep the runtime of the execution of the packages as short as possible, and to finish the execution in the shortest possible time. After execution of the packages, the packages are saved or committed to a database. Saving the data in packages to the database is quick and efficient, because in case a few packages fail to get saved, rolling back the few failed packages in the database is easier compared to saving and rolling back the entire data in the target group. In case the message campaign execution aborts, all the recipients of the target group need not be processed, only the recipients having failed to receive the personalized communication need to be processed again. Therefore, the recipients are sent personalized communication only once and the recipients receive personalized communication only once. This implies that the restarted campaign execution would need only the shortest possible runtime.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

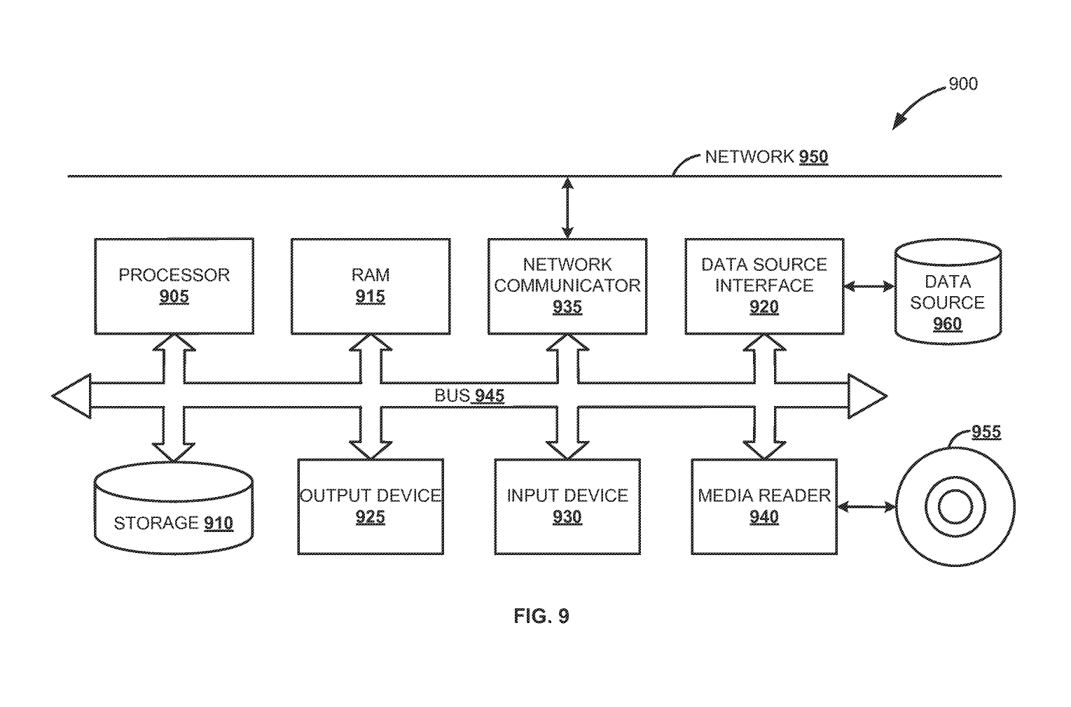

FIG. 9 is a block diagram of an exemplary computer system 900. The computer system 900 includes a processor 905 that executes software instructions or code stored on a computer readable storage medium 955 to perform the above-illustrated methods. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. An article of manufacture including a non-transitory computer readable storage medium to tangibly store instructions, which when executed by a computer, cause the computer to:
define a message campaign based on a plurality of inputs and a target group of recipients assigned to the message campaign;
in response to receiving an execute instruction corresponding to the message campaign, create a mass data run object instance corresponding to the message campaign;
schedule execution of the mass data run object instance based on specified schedule parameters;
group recipients of the target group into packages, wherein the mass data run object instance groups the recipients;
execute the packages in parallel in batches to send corresponding personalized communication to the recipients grouped into the packages by creating a corresponding instance of the recipients; and
upon failure of execution of one or more packages from the packages, restart execution of the one or more packages to send personalized communication to the recipients in the one or more packages, wherein the failure of execution is determined by at least one not contacted recipient reported for the one or more packages, and wherein the recipients are sent personalized communication once.

2. The article of manufacture of claim 1, wherein the mass data run object is processed in a background job.

3. The article of manufacture of claim 1, further comprising instructions which when executed by the computer cause the computer to:
upon failure of execution of a first set of packages from among the packages, restart execution of the first set of packages in parallel in batches to send personalized communication to the recipients in the first set of packages, wherein the recipients receive personalized communication once.

4. The article of manufacture of claim 3, further comprising instructions which when executed by the computer cause the computer to:
restart execution of the first set of packages until personalized communication is sent to the recipients of the first set of packages, wherein the execution is performed in parallel in batches of specified batch size.

5. The article of manufacture of claim 1, further comprising instructions which when executed by the computer cause the computer to:
perform validation check on details of the message campaign and information associated with the recipients in the packages; and
upon successful validation check, execute the packages in parallel in batches to send personalized communication to the validated recipients in the packages.

6. The article of manufacture of claim 1, further comprising instructions which when executed by the computer cause the computer to:
determine an execution status of the message campaign, wherein, based on the execution status of the message campaign, the packages within the message campaign are executed.

7. The article of manufacture of claim 1, wherein restarting execution of the one or more packages further comprises:
perform validation check on details of the message campaign and information associated with the recipients of the one or more packages;
upon successful validation check, execute the one or more packages in parallel in batches to send personalized communication to the validated recipients in the one or more packages; and
based on the execution of the one or more packages, determine and update an execution status of the message campaign.

8. A computer implemented method of restart capability in message campaign, the method comprising:
defining a message campaign based on a plurality of inputs and a target group of recipients assigned to the message campaign;
in response to receiving an execute instruction corresponding to the message campaign, creating a mass data run object instance corresponding to the message campaign;
scheduling execution of the mass data run object instance based on specified schedule parameters;
grouping recipients of the target group into packages, wherein the mass data run object instance groups the recipients;
executing the packages in parallel in batches to send corresponding personalized communication to the recipients grouped in the packages by creating a corresponding instance of the recipients; and
upon failure of execution of one or more packages from the packages, restarting execution of the one or more packages to send personalized communication to the recipients in the one or more packages, wherein the failure of execution is determined by at least one not contacted recipient reported for the one or more packages, and wherein the recipients are sent personalized communication once.

9. The method of claim 8, wherein the mass data run object is processed in a background job.

10. The method of claim 8, further comprising instructions which when executed by the computer cause the computer to:
upon failure of execution of a first set of packages from among the packages, restarting execution of the first set of packages in parallel in batches to send personalized communication to the recipients in the first set of packages, wherein the recipients receive personalized communication once.

11. The method of claim 10, further comprising instructions which when executed by the computer cause the computer to:
restarting execution of the first set of packages until personalized communication is sent to the recipients of the first set of packages, wherein the execution is performed in parallel in batches of specified batch size.

12. The method of claim 8, further comprising instructions which when executed by the computer cause the computer to:
performing validation check on details of the message campaign and information associated with the recipients in the packages; and
upon successful validation check, executing the packages in parallel in batches to send personalized communication to the validated recipients in the packages.

13. The method of claim 8, further comprising instructions which when executed by the computer cause the computer to:
determine an execution status of the message campaign, wherein based on the execution status of the message campaign the packages within the message campaign are executed.

14. The method of claim 8, wherein restarting execution of the one or more packages further comprises:
performing validation check on details of the message campaign and information associated with the recipients of the one or more packages;
upon successful validation check, executing the one or more packages in parallel in batches to send personalized communication to the validated recipients in the one or more packages; and
based on the execution of the one or more packages, determining and updating an execution status of the message campaign.

15. A computer system for restart capability in message campaign, comprising:
a computer memory to store program code; and
a processor to execute the program code to:
define a message campaign based on a plurality of inputs and a target group of recipients assigned to the message campaign;
in response to receiving an execute instruction corresponding to the message campaign, create a mass data run object instance corresponding to the message campaign;
schedule execution of the mass data run object instance based on specified schedule parameters;
group recipients of the target group into packages, wherein the mass data run object instance groups the recipients;
execute the packages in parallel in batches to send corresponding personalized communication to the recipients grouped into the packages by creating a corresponding instance of the recipients; and
upon failure of execution of one or more packages from the packages, restart execution of the one or more packages to send personalized communication to the recipients in the one or more packages, wherein the failure of execution is determined by at least one not contacted recipient reported for the one or more packages, and wherein the recipients are sent personalized communication once.

16. The system of claim 15, wherein the mass data run object is processed in a background job.

17. The system of claim 15, further comprising instructions which when executed by the computer cause the computer to:
upon failure of execution of a first set of packages from among the packages, restart execution of the first set of packages in parallel in batches to send personalized communication to the recipients in the first set of packages, wherein the recipients receive personalized communication once.

18. The system of claim 17, further comprising instructions which when executed by the computer cause the computer to:
restart execution of the first set of packages until personalized communication is sent to the recipients of the first set of packages, wherein the execution is performed in parallel in batches of specified batch size.

19. The system of claim 15, further comprising instructions which when executed by the computer cause the computer to:
perform validation check on details of the message campaign and information associated with the recipients in the packages; and
upon successful validation check, execute the packages in parallel in batches to send personalized communication to the validated recipients in the packages.

20. The system of claim 19, wherein restarting execution of the one or more packages further comprises:
perform validation check on details of the message campaign and information associated with the recipients of the one or more packages;
upon successful validation check, execute the one or more packages in parallel in batches to send personalized communication to the validated recipients in the one or more packages; and
based on the execution of the one or more packages, determine and update an execution status of the message campaign.
